(19) United States
(12) Patent Application Publication
(10) Pub. No.: US 2008/0266915 A1
(43) Pub. Date: Oct. 30, 2008

(54) Converter System Comprising Converter Modules That Can Be Plugged Together

(75) Inventor: Dieter Eckardt, Herzogenaurach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/097,658

(22) PCT Filed: Nov. 6, 2006
(86) PCT No.: PCT/EP2006/068124

§ 371 Date: Jun. 16, 2008

(30) Foreign Application Priority Data
Dec. 16, 2005 (DE) 10 2005 060 354.8

(51) Int. Cl. H02J 4/00

(52) U.S. Cl. 363/65

(57) ABSTRACT

The invention relates to a modular converter system (2). According to the invention, the modular converter system (2) has a basic converter device (4) and at least one additional converter device (6), wherein said devices (4, 6) can be plugged laterally one beneath the other by means of their power-supply and load busbars (8, 10) and by means of a communication line (12). A modular converter system (2), which can be matched individually to any desired power output which may be required without a great deal of complexity, can therefore be achieved.

The invention relates to a modular converter system.

EP 0 600 635 A2 discloses a converter system which has two parallel-connected, load-side converters which are electrically conductively connected on the DC voltage side by means of a DC link. On the AC voltage side, these load-side converters are each connected to one another by means of an inductor, to whose center taps a load is connected. Pulse-width-modulated signals are generated in order to control these two load-side converters, which are electrically connected in parallel. For this purpose, two triangular waveform carrier signals are compared with a three-phase sinusoidal signal system. These two triangular waveform carrier signals have a phase shift of 180° electrical between them. The three sinusoidal signals each have a phase shift of 90° electrical from a carrier signal. The power which is required by a connected load must be first of all be provided in the voltage link by the mains-side converter. This power is then split between the two parallel-connected load-side converters. In comparison to a converter signal with only one load-side converter, the current through each of these two converters is halved. Furthermore, the pulse-width-modulated signals of a generator for the two parallel-connected load-side converters minimize the harmonics in the load voltage.

When inverter branch pairs of parallel inverters are connected in parallel, the different switching times of the controllable semiconductor switches in these inverter branch pairs result in additional loads as a result of balancing currents, driving the feeding DC voltage source through the inverter branches, which are controlled in the same sense. This unbalanced splitting of the currents must be avoided as far as possible.

DE 42 23 804 A1 discloses a method and an apparatus for controlling an m-pulse inverter arrangement, comprising a master inverter and at least one slave inverter. In this case, master and slave control signals are produced from determined phase current actual values of the mast inverter and of a slave inverter, and from control signals for the inverter control equipment. The timings of the switch-on flanks of the control signals for the inverter control equipment are shifted as a function of a determined phase current actual difference, with the switch-off flanks being passed on without any delay. Depending on the mathematical sign of the determined phase current actual difference, these delayed control signals are supplied to the master or the slave inverter, with the control signals of the inverter control equipment being supplied to every other inverter. This balances the splitting of the phase currents.

In addition to minimizing the harmonics in the load current to a load, inverters are also connected in parallel in order to generate a higher power level, while at the same time reducing the phase currents in each inverter. In a converter system such as this, the parallel inverters are fed from a DC voltage source. This means that this DC voltage source, comprising at least one uncontrolled rectifier and one link capacitor, must be designed for the required output power. Connecting the inverters in parallel reduces the current load on each inverter, and therefore on its semiconductor components which can be turned off.

Individual power matching is impossible in this known converter system. In theory, the addition of further inverters makes it possible to increase the output power without significantly increasing the current load on each inverter. However, the greater required power must be provided by the DC voltage source. This means that, when the power required increases, the DC voltage source must likewise be matched to this greater power requirement. In addition, this is not achieved by parallel connection of a further inverter on the inverter side. The control apparatus must likewise be modified for the changed inverter arrangement.

The invention is now based on the object of specifying a converter system which allows a modular power increase without major complexity.

According to the invention, this object is achieved by the features of claim 1.

Since every converter device in the converter system according to the invention has mains and load busbars and a commutation line, which are designed such that they can be plugged in, these converter devices can be arranged in series with one another. When arranged in series, one converter device is plugged onto another converter device at the side. In this case, these converter devices can be detachably mounted directly on the rear wall of a switchgear cabinet, or can be snapped onto a holding rail.

In this converter system according to the invention, a first converter device, a basic converter device, with further converter devices each forming a additional converter device. The basic converter device ensures the definition and the production of a load voltage, while in contrast the additional converter devices each produce an additional current.

Depending on the required output power of the converter system according to the invention, one basic converter device and a predetermined number of additional converter devices are plugged to one another to form a converter device assembly. This results in a converter system of modular design which can be individually matched to the required output power and has continuous mains and load busbars and a continuous communication line. In this converter system, a feeding mains system can therefore be connected either through a basic converter device or to a additional converter device. In this converter system, a load can also be connected to the basic converter device or to an accessible additional converter device.

A nominal current value is supplied to each additional converter device via the looped-through communication line. When a load current (sum current) is measured in the converter system, then each additional converter device is supplied with the n-th part of this measured load current as the nominal current value. If only one measured output current from the basic converter device is available, this is supplied to each additional converter device as the nominal current value. In order to allow a sum current to be measured, a current measurement device is required which has load busbars, with each existing load busbar being provided with a current transformer. Furthermore, the outputs of these current transformers must be linked to a computation apparatus whose output is connected to a communication line. If a commercially available converter device is used as the basic converter device, then it already contains current transformers for determination of converter phase output currents.

In order to allow the basic converter device to supply its proportion of the total current, it is advantageous for the basic converter device to be automatically able to determine the number of additional converter devices. For this purpose, the basic converter device has an apparatus for determining the number of connected additional converter devices, and its two output connections are looped through the additional converter devices. Each additional converter device has a resistor which is electrically conductively connected to the looped-through output connections of the apparatus of the basic converter device when the additional converter device is plugged in. The connection of at least one resistor (additional converter device) results in the apparatus of the basic converter device producing a voltage which is proportional to the number of connected additional converter devices.

If this resistor in each additional converter device is designed to be switchable by means of a switch, it is now possible for one additional converter device to autonomously leave this device assembly, for example in the event of a fault. This allows redundant operation with fault feedback.

In one advantageous embodiment of the modular converter system, the basic and additional converter devices each have a feedback capability. This limits overvoltages which can occur as a result of temporary circulating currents when load changes occur.

In order to explain the invention further, reference is made to the drawing, which schematically illustrates one embodiment of the modular converter system according to the invention.

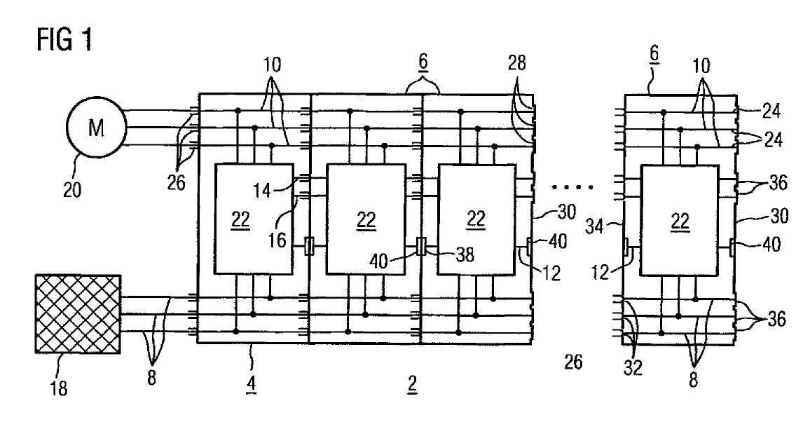

FIG. 1 shows an outline circuit diagram of a modular converter system according to the invention,

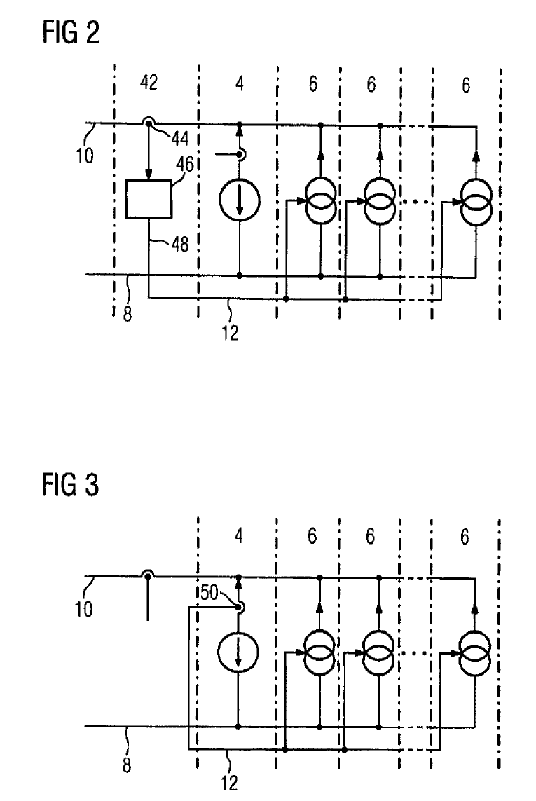

FIG. 2 shows an equivalent circuit of the modular converter system shown in FIG. 1 using a first current measurement method,

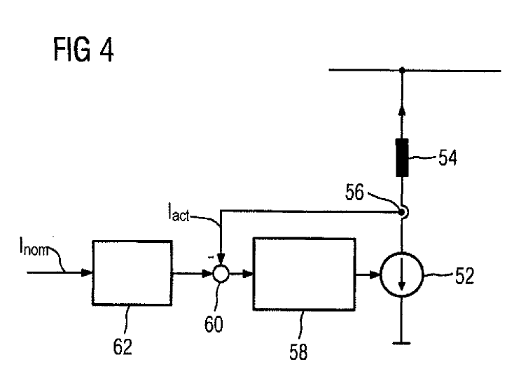

FIG. 3 shows an equivalent circuit of a modular converter system as shown in FIG. 1 using a second current measurement method,

FIG. 4 shows one implementation of a current source by means of a controllable voltage source,

FIG. 5 shows a first apparatus for determining the number of plug-in additional converter devices in the modular converter system shown in FIG. 1,

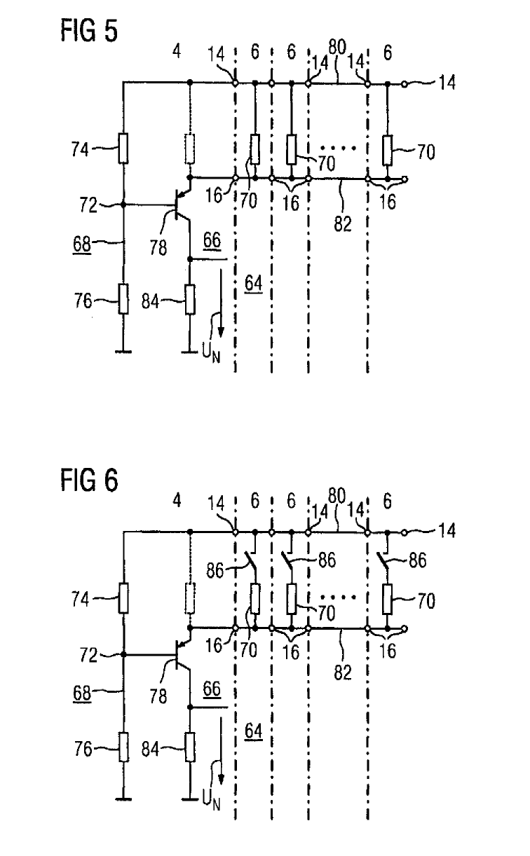

FIG. 6 shows a second apparatus for determining the number of plug-in additional converter devices in the modular converter system shown in FIG. 1,

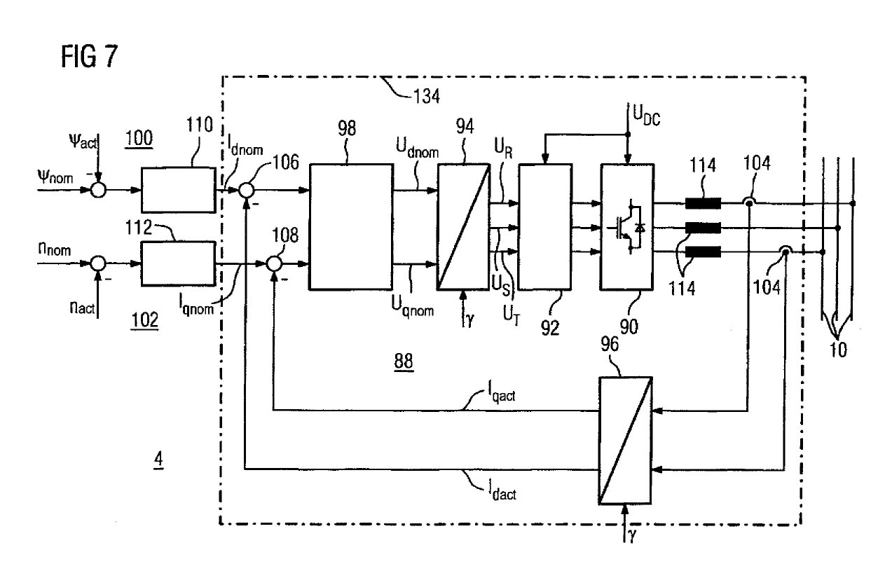

FIG. 7 shows an equivalent circuit of a basic converter device, and

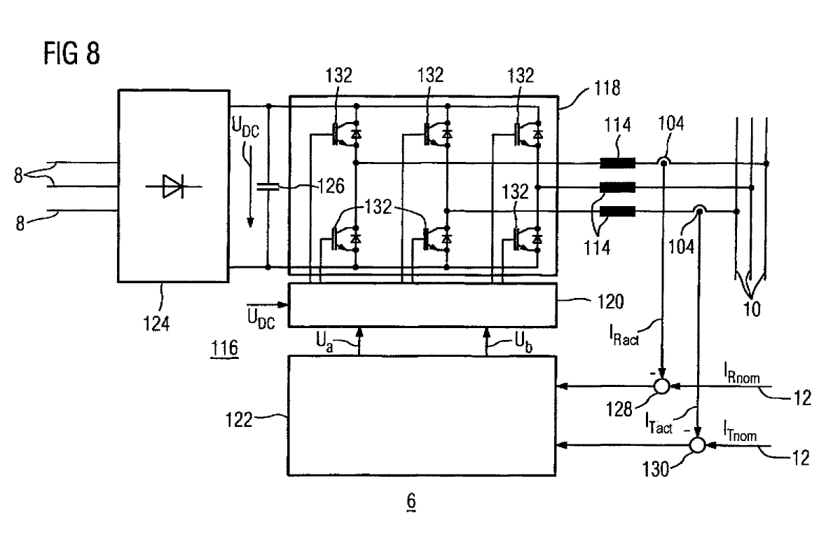

FIG. 8 shows an equivalent circuit of a additional converter device.

As shown in the outline circuit diagram in FIG. 1, the modular converter system 2 according to the invention has a basic converter device 4 and at least one additional converter device 6. Each converter device 4 and 6 has mains and load busbars 8 and 10 and a communication line 12. Since FIG. 1 illustrates one advantageous embodiment of the modular converter system 2 according to the invention, this basic converter device 2 has two output connections 14 and 16, which are looped through the plugged-in additional converter devices 6. In this illustration of the modular converter system 2, a feeding main system 18 is linked to the mains busbars 8 of the basic converter device 4. In addition, a load 20 is linked to the load busbars 10 of the basic converter device 4. A power section, a closed-loop and an open-loop control system for a converter for each converter device 4 and 6, are each combined in the box 22, and are not shown explicitly in this illustration. An equivalent circuit of a converter in the basic converter device 4 is illustrated in FIG. 7, and an equivalent circuit of a converter for an additional converter device 6 can be seen in FIG. 8.

In order to allow these converter devices 6 to be plugged onto one another at the side by means of their mains and load busbars 8 and 10, these busbars 8 and 10 each have a plug and holding part 24 and 26. These plug parts 24 of the busbars 8 and 10 are accessible through recesses 28 in a first side wall 30 of each converter device 4 and 6. The associated holding parts 26 for the busbars 8 and 10 project through recesses 32 in a second side wall 34 of each converter device 4 and 6. The recesses 28 in the side wall 30 of the last additional converter device 6 in this modular converter device assembly are each closed by a cover 36. The design of this cover 36 depends on the required degree of protection for the module converter device assembly. The communication line 12 of each converter device 4 and 6 is electrically conductively connected at each of the two ends to a first part 38 and to a second part 40 of an apparatus which can be plugged in. These parts 38 and 40 of each apparatus which can be plugged in are in each case arranged in one side wall 34 and 30 of two converter devices 4 and 6, or 6 and 6, which can be plugged onto one another at the side. When two converter devices 4 and 6 or 6 and 6 are plugged together, these parts 38 and 40 of an apparatus which can be plugged in engage in one another.

Since each converter device 4 and 6 has mains and load busbars 8 and 10 and a communication line 12, these busbars 8 and 10 and this communication line 12 automatically grow further. When a basic converter device 4 and at least one additional converter device 6 are plugged together, these busbars 8 and 10 and this communication line 12 appear as if they were looped through them.

FIG. 2 shows an equivalent circuit of a modular converter system 2 as shown in FIG. 1 using a first current measurement method. In this equivalent circuit, the converter device 4 is represented by a controllable voltage source, and the additional converter devices 6 are each represented by a controllable current source. Only one busbar of the main and load busbars 8 and 10 is in each case shown. In addition, this equivalent circuit has a current measurement device 42, and the mains and load busbars 8 and 10 have a current transformer 44 for each load busbar 10 that is present, and a computation apparatus 46. On the output side, this computation apparatus 46 is electrically conductively connected to the looped-through communication line 12. For this purpose, this current measurement device 42 has a line 48 which is electrically conductively connected to a second part 40 of an apparatus which can be plugged in. This second part 40 is arranged on a side wall of this current measurement device 42 such that, when plugged in, this second part 40 engages in a first part 38 of the basic converter device 4. The computation apparatus 46 forms a current sum value from the individual current measurement variables. This current sum value is divided by the number of additional converter devices plugged into the modular converter system 2. This n-th part of the determined current sum value is supplied by means of the communication line 12 to each additional converter device 6 as the current nominal value Iₙₒₘ. Since this measurement method uses an additional current measurement device 42, a load 20 must be linked to the load busbars 10 of this current measurement device 42. This current measurement device 42 can either be plugged in at the side to the basic converter device 4 or else can be plugged onto a freely accessible side wall 30 of an additional converter device 6. In addition to the increased component complexity, the current transformer 44 must be designed for the load current and not for a fraction of this load current.

FIG. 3 shows an equivalent circuit of the modular converter 2 shown in FIG. 1, using a second current measurement method. In this current measurement method, the basic converter device 4 has an least one current transformer 50, and these current transformers are arranged in the output lines of the converter in this converter device 4. The output of each current transformer 50 in the basic converter device 4 is connected by means of the looped-through communication line 12 to each additional converter device 6. The converter output current from the basic converter device 4 is transmitted to each additional converter device 6 as the current nominal value Iₙₒₘ. In this measurement method, there is no need to link a load 20 to the modular converter system 2 at a predetermined point. This means that the load 20 can be connected to the basic converter device 4 or to a freely accessible additional converter device 6 in this converter device assembly.

These two additional circuits also show that the basic converter device 4 is operated as a controllable voltage source, and each additional converter device 6 is operated as a controllable current source. This means that the basic converter device 4 is used in the same way as a commercially available converter device while, in contrast, the additional converter devices 6, which are each likewise a controllable voltage source, are used as current sources.

FIG. 4 shows one implementation of a controllable current source by means of a controllable voltage source 52, in more detail. An inductor 54 is connected upstream of this controlled voltage source 52. A current transformer 56 is used to measure the output current from the controlled voltage source 52, and this is supplied as the actual current value to a closed-loop current control system, comprising a current regulator 58 and a comparator 60. As already mentioned, the output current from the converter in the basic converter device 4 is supplied as the nominal current value to each additional converter device 6. This nominal current value is passed by means of a reference variable former 65, for example a filter, to the non-inverting input of the comparator 60 for the closed-loop current control system. In order to ensure on the one hand that the closed-loop current control system for each additional converter device 6 has a wide dynamic range and on the other hand that the inductor 54 can be kept small, it is expedient to choose the pulse repetition frequency of the controlled voltage source 52 to be as high as possible. A high pulse repetition frequency increases the load on the semiconductor switches which can be turned off in the controlled voltage source 52. It is therefore highly advantageous for these semiconductor switches which can be turned off to be composed of silicon carbide. The high pulse repetition frequency also means that each additional converter device 6 has a wide dynamic control range, as a result of which the additional converter devices 6 can each follow the basic converter device 4 quickly and with only a slight phase lag.

FIG. 5 shows in more detail a first embodiment of an apparatus 64 for determining the number of additional converter devices 6 plugged into the modular converter system 2. This apparatus 64 on the one hand has a constant current source 66 with a voltage divider 68 and parallel load resistors 70. This constant current source 66 with the voltage divider 68 is arranged in the basic converter device 4 while, in contrast, one load resistor 70 is arranged in each additional converter device 6. The junction point 72 between the two resistors 74 and 76 in the voltage divider 68 is connected to the control connection of a transistor 78 in the constant current source 66. The emitter connection of this transistor 78 forms one output connection 16 while, in contrast, one connection of the resistor 74 in the voltage divider 68 forms the other output connection 14. These output connections 14 and 16 are looped through the additional converter devices 6 by means of lines 8 and 82. This means that each additional converter device 6 likewise also has two lines 80 and 82, which are each provided with a plug and holding part. A voltage UN which is proportional to the number of plugged-in additional converter devices 6 is dropped across the collector resistance 84 of the constant current source 66.

FIG. 6 shows a second embodiment of the apparatus 64 for determining the number of additional converter devices 6 plugged into the modular converter system 2. This second embodiment differs from the embodiment shown in FIG. 5 in that each load resistor 70 has an associated switch 86. One load resistor 70 and one associated switch 86 are electrically connected in series. This switch 86 allows an associated additional converter device 6 to be disconnected from this plugged-in converter device assembly without having to be physically removed from this converter device 7. If one additional converter device 6 has a defect, it can therefore automatically be disconnected from the converter device assembly, thus allowing redundant operation with fault feedback.

FIG. 7 shows an equivalent circuit of a converter 88 in a basic converter device 4. In this equivalent circuit, 90 denotes a load-side converter for the converter 88, 92 denotes a pulse modulator, 94 and 96 each denote a vector rotator, 98 denotes a closed-loop current control system, and 100 and 102 denote closed-loop flux control and closed-loop rotation speed control. On the DC voltage side, a DC voltage U_{DC} which is produced by a DC voltage source that is not illustrated in any more detail is applied to the load-side converter 90. This DC voltage source comprises, for example, a diode feed (rectifier) and a voltage link with at least one capacitor, in particular an electrolytic capacitor. A converter 88 such as this is also referred to as a voltage-source converter. The DC voltage U_{DC} is supplied to the pulse modulator 92. Pulse-width modulated signals are produced at the outputs of the pulse modulator 92 and then used to generate drive signals for the semiconductor switches which can be turned off in the load-side converter 90. For this purpose, this load-side converter 90 has a drive device. The closed-loop flux control 100 and the closed-loop rotation speed control 102 and the closed-loop current control 98 form a so-called control device which in this case is a field-oriented closed-loop control system. The load-side converter 90 has at least two current transformers 104 on the output side, and their output sides are linked by means of the vector rotator 96 to a comparator 106 and 108. One output of a flux regulator 110 for closed-loop flux control 100 is connected to the non-inverting input of the comparator 106. One output of a rotation-speed regulator 112 is connected to the non-inverting input of the comparator 108, for closed-loop rotation speed control 102. An orthogonal current component I_{dact} and I_{qact} is produced at the respective output connections of the vector rotator 96, and these components are respectively compared with a current component nominal value I_{dnom} and I_{qnom} for the closed-loop flux control 100 and the closed-loop rotation speed control 102. The closed-loop current control 98 uses the determined current component difference values to produce two orthogonal voltage components U_{dnom}, U_{qnom}, from which three phase voltage nominal values U_{R}, U_{Y} and U_{B} are generated by means of the vector rotator 94. To carry out their work, these vector rotators 94 and 96 require a rotation angle γ. In this equivalent circuit of the converter 88, the outputs of the load-side converter 90 are each provided with an optional inductor 114. This equivalent circuit of the converter 88 corresponds to that of a commercially available voltage-source converter with field-oriented closed-loop control. This converter 88 is used to generate a voltage that is required for the load 20. This converter 88 is therefore used as a controlled voltage source.

FIG. 8 shows in more detail an equivalent circuit of a converter 116 for an additional converter device 6. In this equivalent circuit, 118 denotes a load-side converter, 120 a pulse modulator, 122 a two-variable current regulator, 124 a main-side converter and 126 a link capacitor. The outputs of this load-side converter 118 each have an inductor 114. The two current converters 104 are each electrically conductively connected on the output side by means of a comparator 128 and 130 to the two-variable current regulator 122 which, for example, is integrated in a decoupling network. A current nominal value I_{Rnom} and I_{Tnom} are respectively applied to the non-inverting inputs of the two comparators 128 and 130, having been provided from the basic converter device 4 by means of a communication line 12. One determined phase current difference value is in each case supplied to the two-variable current regulator 122, which uses this to generate two components Uₐ and U_{b} of a manipulated variable. These components Uₐ and U_{b} of this manipulated variable are supplied to the pulse modulator 120, from which pulse-width-modulated control signals are generated as a function of a DC voltage U_{DC} across the link capacitor 126. The mains-side converter 124 is in this case a rectifier and can also be designed to have a feedback capability. A so-called active front end (AFE) or a so-called fundamental frequency front end (F³E) may be used as a mains-side converter 124 with a feedback capability. The three inductors 114, can also be replaced by sinusoidal filters.

The inductors 114 as shown in FIG. 4 have to be provided for this controlled voltage source to act as a current source. These inductors 114 on the one hand prevent short circuits between the converter devices 4 and 6, and also ensure a specific closed-loop control range. The size of these inducters 114 is essentially also covered by the pulse repetition frequency of the controlled voltage source since it must temporarily store the energy from the voltage time-integral differences between the basic converter device 4 and the additional converter device 6, or between two additional converter devices 6 in the converter device assembly. Since the pulse repetition frequencies of the inverters 88 and 116 of all the converter devices 4 and 6 in the converter system 2 according to the invention are not synchronized, a switching frequency which is as high as possible should be chosen for the converters 116 in the additional converter devices 6. In order to ensure that the switching losses in the load-side converter 118 do not become excessive, it is advantageous for the semiconductor switches 132 which can be turned off in this load-side converter 118 to be composed of silicon carbide (SiC). A high pulse repetition frequency also ensures that the control dynamic range of the additional converter devices 6 is wide, thus allowing the additional converter devices 6 to follow the basic converter device 4 quickly and with little phase lag.

Instead of a voltage-source converter 116, a current-source converter in the form of a controlled current source can also be used as a converter for each additional converter device 6. If a voltage-source converter 116 is in each case used as the converter for each additional converter device 6, then this can also be designed in a corresponding manner to that part of the voltage-source converter 88 outlined by a dashed-dotted line 134 in FIG. 7, with field-oriented closed-loop control.

Since, in this modular converter system 2, the required power output is made available by at least one additional converter device 6, by means of one basic converter device 4, any required power output can be produced individually by the addition or removal of additional converter devices 6. Since these converter devices 4 and 6 in this modular converter device assembly contain mains and load busbars 8 and 10 which are designed such that they can be plugged in, these busbar systems 8 and 10 are not lengthened when further additional converter devices 6 are added. These busbar systems 8 and 10 are automatically extended when a further additional converter device 6 is plugged to an existing converter device assembly.

1.-21. (canceled)

22. A modular converter system, comprising:
a basic converter device configured as a voltage-source converter operated as a controllable voltage source and having a side panel with a power mains busbar, a load busbar and a communication line, and
at least one additional converter device configured as a voltage-source converter and having a side panel with a power mains busbar, a load busbar and a communication line,
wherein the power mains busbars, the load busbars and the communication lines of different converter devices are electrically connected when the different converter devices are joined at their respective side panels.

23. The modular converter system of claim 22, wherein the at least one additional converter device operates as a controllable current source.

24. The modular converter system of claim 22, comprising a plurality of additional converter devices, wherein the additional converter devices are clocked independently of one another at a high pulse repetition frequency.

25. The modular converter system of claim 22, wherein the basic converter device and the at least one additional converter device each have feedback capability.

26. The modular converter system of claim 22, wherein the basic converter device comprises a device for determining a number of connected additional converter devices and two output connections, and wherein each connected additional converter device comprises a load resistor connected to the two output connections.

27. The modular converter system of claim 22, further comprising a current measurement unit with a current converter for measuring a current in the load busbar, and a computation unit, wherein an output of the current converter is connected to an input of the computation unit and an output of the computation unit is connected to the communication line.

28. The modular converter system of claim 27, wherein the measured current in the load busbar is divided by a number of additional converter devices, and each additional converter device receives as a nominal current value a fraction of the measured current commensurate with the number of additional converter devices.

29. The modular converter system of claim 22, wherein each additional converter device receives as a nominal current value a measured output current from the basic converter device.

30. The modular converter system of claim 26, wherein the load resistor of each additional converter device is electrically connected in series with a switch.

31. The modular converter system of claim 22, wherein the basic converter device and the at least one additional converter device each comprise a mains-side converter configured as an active front end.

32. The modular converter system of claim 22, wherein the basic converter device and the at least one additional converter device each comprise a fundamental frequency front end.

33. The modular converter system of claim 22, wherein the at least one additional converter device comprises turn-off semiconductor switches composed of silicon carbide.

34. The modular converter system of claim 27, further comprising a load connected to the load busbar of the current measurement unit.

35. The modular converter system of claim 22, further comprising a load connected to the load busbar of the basic converter device.

36. The modular converter system of claim 22, further comprising a load connected to the load busbar of the at least one additional converter device.

37. The modular converter system of claim 22, wherein the power mains busbar and the load busbar each have a plug part and a receptacle part.

38. The module converter system of claim 37, wherein a first side panel of the basic converter device and a first side panel of the at least one additional converter device each have an opening providing access to the plug part of the power mains busbar and the plug part of the load busbar.

39. The modular converter system of claim 37, wherein a second side panel of the basic converter device and a second side panel of the at least one additional converter device each have an opening through which the receptacle part of the power mains and the receptacle part of the load busbar protrude.

40. The modular converter system of claim 22, wherein the basic converter device and the at least one additional converter device each comprise a plug connector having a first part arranged in an opening in a corresponding first side panel and a second part arranged in an opening in a corresponding second side panel, wherein ends of the computation line of each unit are electrically connected to the first part and the second part of the plug connector of that unit, and the first part of the plug connector of one unit is configured to mate with the second part of the plug connector of another unit when the units are joined along their respective side panels.
